(19) United States
(12) Patent Application Publication
(10) Pub. No.: US 2008/0093350 A1
(43) Pub. Date: Apr. 24, 2008

(54) SUPERFINE/NANOSTRUCTURED CORED WIRES FOR THERMAL SPRAY APPLICATIONS AND METHODS OF MAKING

(75) Inventors: Xinqing Ma, Willington, CT (US); Meidong Wang, Amherst, CT (US); T. Danny Xiao, Willington, CT (US)

Correspondence Address: CANTOR COLBURN, LLP, 20 Church Street, 22nd Floor, Hartford, CT, 06103, US

(73) Assignee: Inframat Corporation, Farmington, CT (US)

(21) Appl. No.: 11/874,723

(22) Filed: Oct. 18, 2007

Related U.S. Application Data
(60) Provisional application No. 60/862,039, filed on Oct. 18, 2006.

(51) Int. Cl. B23K 35/12; B22F 3/20; B23K 35/40; C23C 4/16; B22F 5/12

(52) U.S. Cl. 219/145.1; 419/3; 419/67; 427/446; 427/455

(57) ABSTRACT

Cored wires having a core comprising agglomerates of superfine particles and/or nanoparticles for thermal spray or overlay weld applications and methods of making the same are provided. Methods of coating a substrate by thermal spraying such as electric arc spraying with such cored wires are also provided. In an embodiment, a cored wire comprises a metallic sheath at least partially surrounding a core comprising agglomerates of superfine particles, nanoparticles, or a combination comprising at least one of the foregoing particles.

### CROSS REFERENCE TO RELATED APPLICATION

This application claims the benefit of U.S. Provisional Patent Application No. 60/862,039 filed Oct. 18, 2006, which is incorporated by reference herein in its entirety.

### TECHNICAL FIELD

The present disclosure generally relates to cored wires, and more specifically to cored wires having a core comprising agglomerates of nanoparticles and/or superfine particles for thermal spray or overlay weld applications.

### BACKGROUND

A wide variety of protective coatings are used in industry for corrosion, erosion, and wear resistance of components in machinery such as valves, pumps, water boilers, turbine engines, pipe systems, and the like. In many industry applications, component degradation and failure are caused by corrosion, wear, high temperature oxidation, hot corrosion, sulfidation, erosion, and so forth. As a result, the lifetimes of such components are reduced. Surface modification and coating techniques have proven to be effective methods to reduce damage and degradation to components and thus prevent the failure thereof.

Thermal spray techniques, including electric arc spray, plasma spray, high velocity oxygen fuel (HVOF) spray, detonation spray, combustion flame spray, cold spray, and the like, have been employed to apply a wide range of coating materials to substrate surfaces. Wires have been used as feed materials mainly in electric arc spray and occasionally in combustion flame spray and plasma spray. In electric arc spray, DC electricity is supplied to two electrodes (one or both are wires), and an electric arc is induced between the tips of the electrodes to melt the electrode wire(s). An air or gas jet blows and atomizes the molten metal into droplets and transfers the droplets toward a substrate. The droplets impact the substrate at a high velocity and solidify to a solid deposit or layer. The advantages of wire electric arc spraying include (i) high productivity, (ii) well-controlled process, and (iii) relatively low cost.

Until the 1970's, electric arc spray mainly employed pure metal wires such as zinc and aluminum wires for droplet formation in producing cathodic protection coatings in atmospheric, underground, and marine environments. Later, wires made of aluminum-magnesium, zinc-aluminum, and stainless steel alloys were employed for better corrosion resistance and even higher temperature applications. Those wires were solid and had a single chemical composition.

Cored wires have been developed that include a metallic shell or sheath of metal surrounding a core that includes a powder, a mixture of powders, or a metal wire. The cored wires have been utilized to make coatings by thermal spraying, particularly electric arc spraying, and by an overlay weld process. They exhibit improved melting and flux capability during electric arc spraying and increased weldability of the coating produced therefrom.

### BRIEF SUMMARY

Disclosed herein are cored wires having a core comprising agglomerates of nanoparticles and/or superfine particles for thermal spray and overlay weld applications. In one embodiment, a cored wire comprises a metallic sheath at least partially surrounding a core comprising agglomerates of superfine particles, nanoparticles, or a combination comprising at least one of the foregoing particles.

In another embodiment, a method of making a cored wire comprises: agglomerating superfine particles, nanoparticles, or a combination comprising at least one of the foregoing particles to form agglomerates; shaping a metallic strip into a U-shaped tube; concurrently feeding the U-shaped tube to a die and the agglomerates to an interior of the U-shaped tube; and closing the U-shaped tube to form a sheath at least partially surrounding the agglomerates, thereby forming the cored wire.

In yet another embodiment, a method of coating a substrate comprises thermal spraying a coating on a surface of the substrate using a cored wire, the cored wire comprising a metallic sheath at least partially surrounding a core comprising agglomerates of superfine particles, nanoparticles, or a combination comprising at least one of the foregoing particles.

The above described and other features are exemplified by the following detailed description and figures.

### BRIEF DESCRIPTION OF THE DRAWINGS

Referring now to the figures, which are exemplary embodiments and wherein like elements are numbered alike:

FIGS. 1(a)-1(d) are schematic illustrations of various embodiments of cored wires having a core comprising agglomerates of nanoparticles and/or superfine particles;

FIG. 2 is a flow chart of an embodiment of the process for producing the cored wires;

FIG. 3 is a schematic illustration of an embodiment of an integrated die device for making a cored wire;

FIG. 4 is an optical microscope image of an end-view of a cored wire comprising an alloy sheath and a core comprising agglomerates of tungsten carbide-cobalt (WC/Co) nanoparticles;

FIG. 5 is an optical microscope image of a side-view of the same cored wire as depicted in FIG. 4; and

FIG. 6 is optical microscope image of a cross-section of an electric arc sprayed coating formed using a cored wire comprising an alloy sheath and a core comprising agglomerates of WC/Co nanoparticles.

### DETAILED DESCRIPTION

Described herein are cored wires comprising a metallic sheath at least partially surrounding a core that includes agglomerates of superfine particles, nanoparticles, or a combination comprising at least one of the foregoing particles. As used herein, the term “superfine particles” refers to particles having a grain size of about 100 nanometers (nm) to about 1 micrometer (micron), more specifically about 100 nm to about 0.5 micron, and even more specifically about 100 nm to about 0.3 micron. Moreover, the term “nanoparticles” refers to particles having a grain size of less than about 100 nm, more specifically less than about 50 nm, and even more specifically less than about 20 nm.

The wires can be used in thermal spraying processes, such as electric arc spray, combustion flame spray, and plasma spray, and in overlay welding processes to form coatings on components that exhibit superior resistance to wear, cavitation, erosion, corrosion, high temperature oxidation, hot corrosion, and/or sulphidation. The resultant coatings also can have improved hardness, adhesion, toughness, strength, and lubrication properties. Industrial applications of such coatings include slurry pumps, ball valves, gate valves, drill bits, bear seats, pistons, exhausting fans, chutes, plows, shafts, agitators, mineral and ash-handing equipment, rollers, boiler tubes and fire walls.

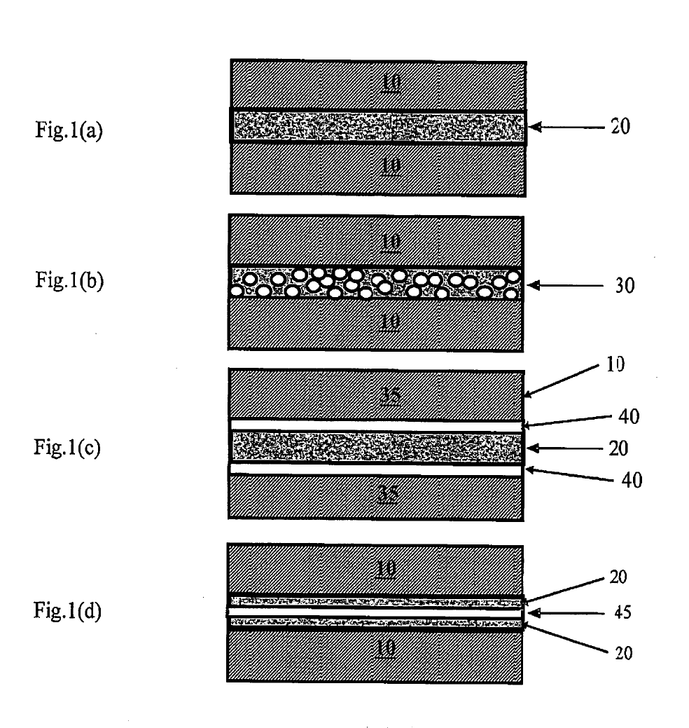

Turning now to the Figures, FIGS. 1(a)-1(d) illustrate exemplary embodiments of the cored wires disclosed herein. FIG. 1(a) depicts one embodiment in which a cored wire includes a metallic sheath 10 surrounding a core filling 20 comprising agglomerates of superfine particles and/or nanoparticles. As used herein, the term “metallic” refers to a material primarily comprising metal such as a pure metal or an alloy comprising more than one metal. The agglomerates can have an average size of about 10 microns to about 200 microns, more specifically about 10 microns to about 100 microns, and even more specifically about 20 microns to about 60 microns. Examples of suitable metallic materials for use in the metallic sheath 10 include but are not limited to metals such as Ni, Co, Cu, Al; alloys such as Fe—Cr, Co—Cr, Ni—Cr, Fe—Cr—Al, and INCONEL® 625 Ni—Cr—Mo superalloy commercially available from Alloy Wire International Ltd.; and steels such as low and high carbon steels and stainless steels 304 and 316. Examples of suitable materials for use in the core filling 20 include but are not limited to metal oxides such as Al₂O₃, Cr₂O₃, TiO₂, SiO₂, CeO₂, Y₂O₃, and ZrO₂; carbides such as WC, W₂C, Co₃W₃C, Cr₃C₂, TiC and B₄C; nitrides such as BN, AlN, Si₃N₄, and sialon; borides such as TiB₂, WCoB, MoCoB, NbCoB and ZrB₂; and lubricants such as Fe₃O₄, FeS, graphite, MoSi₂ and BN, which act as solid-state lubricants, polymers, and CaF₂; single phase or composite dispersion strengthening additives such as Al₂O₃ and CeO₂ dispersions in Al, Cr, or Ti-rich mixed powders; alloy additives comprising mixtures of rich elements such as Zn, Al, Cr, Ti, Mo, W, Nb, Y, B, and Si; and combinations comprising at least one of the foregoing core materials. If the core filling 20 includes both superfine particles and nanoparticles, the superfine particles and the nanoparticles can have the same composition or different compositions.

FIG. 1(b) depicts another embodiment similar to the one shown in FIG. 1(a) except that the core filling 30 includes micron-sized metallic particles dispersed in agglomerates of superfine particles and/or nanoparticles. As used herein, the term “micron-sized particles” refers to particles having a grain size of about 1.0 micron to about 200 microns, more specifically about 10 microns to about 100 microns, and even more specifically about 20 microns to about 60 microns. Examples of suitable materials for use in the micron-sized particles include but are not limited to high activity pure metals such as Al, Ti, Cr, Y, Mg and Zn; noble metals such as Mn, W, Ta, Nb and Mo; alloys such as Ti—Al, Ni—Al, Ni—Cr and Al—Zn; and combinations comprising at least one of the foregoing materials. During an electric arc spray process employing this cored wire, the metallic sheath 10 can experience melting. Meanwhile, the metallic particles in the core filling 30 can melt and bind around the agglomerates. The sheath material and the core materials can then undergo mixing and alloy together. The presence of the metallic powder in the core mixture can act as a liquid binder to promote the incorporation and distribution of the agglomerates into the molten sheath matrix in a liquid-state sintering reaction. High alloy content coatings with fine particle dispersions for corrosion and wear resistance can be formed using this cored wire.

FIG. 1(c) depicts yet another embodiment similar to the one shown in FIG. 1(a) except that the metallic sheath 10 includes two or more layers. For example, the metallic sheath can be a bi-layered sheath comprising an outer alloy shell 35 and an inner metal shell 40 that is compatible with the outer shell 35. Examples of suitable materials for use in the outer alloy shell 35 are the same as those suitable for use in the metallic shell shown in FIG. 1(a). Examples of suitable materials for use in the inner metal shell 40 include but are not limited to high activity pure metals such as Al, Ti, Cr, Y, Mg and Zn; noble metals such as Mn, W, Nb, Ta and Mo; alloys such as Ti—Al, Ni—Al, Ni—Cr and Al—Zn; and combinations comprising at least one of the foregoing materials. The addition of the inner shell 40 can serve as a source of high alloy content in coatings formed using the bi-layered sheath cored wire. The inner shell 40 is expected to produce exothermal heat during the electric arc spray process, thus increasing flux flattening of the droplets upon the substrate for high bond strength. Therefore, this cored wire can be used to form high activity alloy coatings with oxide dispersions that have improved corrosion, oxidation and/or wear resistance. The resultant coatings can also exhibit a relatively high bonding strength, high density, and high hardness.

FIG. 1(d) depicts still another embodiment similar to the one shown in FIG. 1(a) except that a metallic wire 45 extends through the core filling 20. The metallic wire 45 can include superfine particles and/or nanoparticles. The fine metallic wire 45 can be positioned relative to the center line of the core filling 20. Examples of suitable materials for use in the metallic wire 45 include but are not limited to high activity pure metals such as Al, Ti, Y, Zn, Mo, W, and Cr; alloys such as Ni—Al, Ti—Al, and Ni—Cr—Al—Y; compounds such as Ni₃Al; and combinations comprising at least one of the foregoing materials. The addition of the metallic wire 45 can serve as a source of high alloy content in coatings formed using this type of cored wire. The metallic wire 45 can be expected to increase the distribution of the agglomerates during the electric arc spray process, thus increasing chemical uniformity and mechanical integrity in the resultant coatings. The resultant coatings can also exhibit higher catalytic activity and better corrosion, oxidation, and/or wear resistance and can have less oxidized inclusions. They can also exhibit a relatively high bonding strength, high density, and high hardness.

In an additional embodiment, the core filling described in the foregoing embodiments can include multimodal agglomerates comprising micron-sized particles in addition to the superfine particles and/or nanoparticles. The agglomerates can have an average size of about 10 microns to about 200 microns, more specifically about 10 microns to about 100 microns, and even more specifically about 20 microns to about 60 microns.

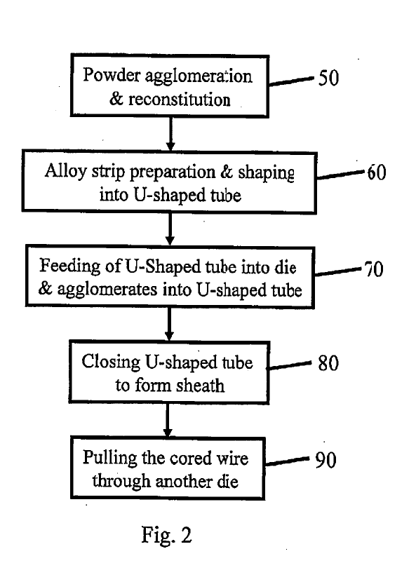

An exemplary embodiment of a process for manufacturing the cored wires is illustrated in FIG. 2. The process begins by agglomerating and reconstituting the superfine particles, nanoparticles, etc. into spheres or sphere-like agglomerates (step 50). In particular, the particles can be dispersed in an aqueous solution comprising a surface wetting agent and a binder such as polyvinyl alcohol to form a slurry using continuous mechanical agitation. When two or more powders having relatively large differences in density or size are placed in the slurry, ball-milling can be employed to ensure the compositional evenness of the slurry. The slurry can then be spray dried by feeding it to a hot chamber via an atomizer to agglomerate and reconstitute the particles. Spray dry parameters can be selected and controlled to produce agglomerates having a narrow size distribution of, e.g., about 20 to about 50 microns. The packing density of the core can be increased by using agglomerates having bi-modal or multi-modal size distributions. To ensure the flowability of the agglomerates, the agglomerates can be subjected to size classification. To increase the density of the agglomerates, the agglomerates can be further subjected to post treatment such as sintering or re-melting.

The next part of the process involves degreasing, cleansing, and drying a metallic strip, followed by shaping or bending the strip into a U-shaped tube using suitable forming rollers (step 60). Subsequently, the U-shaped tube can be fed to a die, and the agglomerates can be concurrently fed to an interior of the U-shaped tube at a constant feeding rate via a powder feeder and a powder port (step 70). The U-shaped tube can then be closed to form a sheath at least partially surrounding the agglomerates via rotation of a pair of screws disposed at the end of the die (step 80). The rotating screw set can also drive the feeding of the U-Shaped tube through the die. This step can gradually reduce the closed tube to a small diameter accompanying the high density packing of the core filling. The use of an integrated die device can ensure that the sheath is tightly closed just after it is filled and has a smooth surface and even diameter. The use of agglomerated powders as the fill material can provide for steady feeding into the U-shaped tube, thus increasing the packing density of the agglomerates in the cored wire. Finally, the resultant cored wire can be pulled through another die to reduce its diameter to a pre-selected diameter size (step 90). The process disclosed herein is applicable for making various types of cored wires disclosed herein.

To form the embodiment of the cored wire shown in FIG. 1(b), the above-described process can be altered by mechanically mixing the agglomerates with the metallic micron-sized particles after they are formed. For the embodiment shown in FIG. 1(c), the process can be altered by depositing a metal layer upon an alloy layer to form the pre-bending strip. For the embodiment shown in FIG. 1(d), the additional fine metallic wire can be positioned relative to the center line of the core filling 20 using, e.g., a guide roller, and fed simultaneously with the agglomerates to the U-shaped tube.

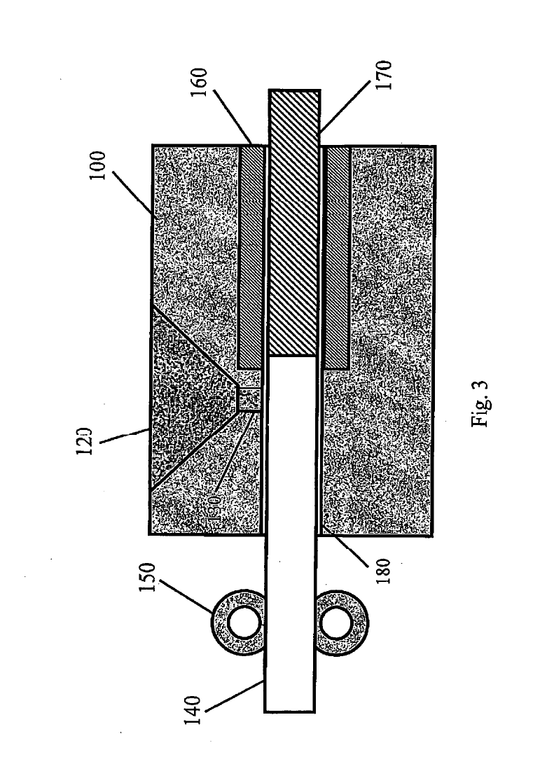

An exemplary embodiment of an integrated die device for making a cored wire is illustrated in FIG. 3. The device includes an intrusion die body 100 integrated with a powder feeder 120 and powder port 130. Forming rollers 150 can be utilized to bend a metallic strip into a U-shaped tube as it moves through a channel 180. The agglomerates of superfine particles and/or nanostructured particles, etc. can pass into the U-shaped tube via powder feed 120 and powder port 130. A screw system 160 can be used to drive the movement of the U-shaped tube through the channel 180 and also provide a compression force to close the L-shaped tube. The closed wire 170 exiting the channel 180 is ready for further size reduction.

An electric arc spray process can be performed to form coatings for different applications. In particular, an electric arc can be induced between the tips of two wire electrodes to melt the electrodes, wherein one or both of the electrodes include a cored wire described herein. An air or gas jet can then be directed toward the molten electrodes to blow and atomize them into droplets and transfer the droplets toward a substrate where they can solidify. During the coating process, the sheath can melt and the inert agglomerated particles can become distributed into the metallic sheath matrix. The chemically active agglomerated particles can be thermally decomposed and alloyed with the molten sheath materials. The highly active agglomerated particles can produce exothermal heat during the spray process to promote melting, fluxing, and alloying of the wire materials. For example, flux flattening of the molten droplets on the substrate can be increased to form a less defective and highly bonded coating. The agglomerates can also act as active agents that cleanse and/or wet the substrate surface for creating a strong bond with the substrate surface. The coating that is produced can be further treated to improve its microstructure and properties. For example, it can be heat treated, sealed, re-melted, or subjected to shot peening.

As described previously, coatings formed using the foregoing cored wires have superior properties. The coatings can have a different composition, a different phase structured, and/or a different microstructure from the sheath and the core of the cored wire. For example, the coating can include a primary metallic phase and a secondary metallic-rich phase structure. It can also include, for example, a microstructure comprising a metallic phase matrix with superfine particles, nanoparticles, and/or other core particles. Different compositions of the coatings can be formed based on the properties desired. For better corrosion resistance, coatings including Fe, Co, or Ni-based alloys with high Cr, Al, Ti, Zn, Mo, Si, and/or B contents can be formed. For better wear resistance, coatings including Fe, Co, or Ni-based alloys with high Cr, W, Mo, Mn, and/or oxide contents can be formed. For better erosion resistance, coatings including Fe, Co, or Ni-based alloys with high oxide, carbide, and/or nitride contents can be formed. For better high temperature oxidation resistance, coatings including Fe, Ni, or Co-based alloys with high Cr, Al, Si, and/or Y contents can be formed. For better lubricity, coatings including Fe, Co, or Ni-based alloys with high Cr, Mn, Mo, B, FeS, MoSi₂, and/or BN contents can be formed.

The invention is further illustrated by the following non-limiting examples.

### EXAMPLES

### Example 1

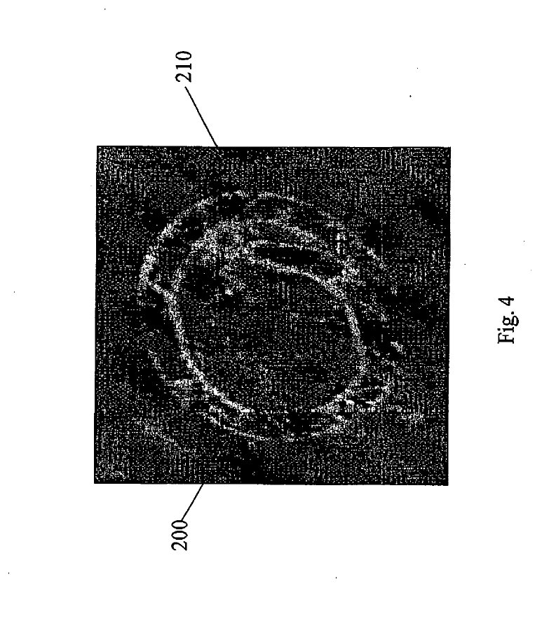

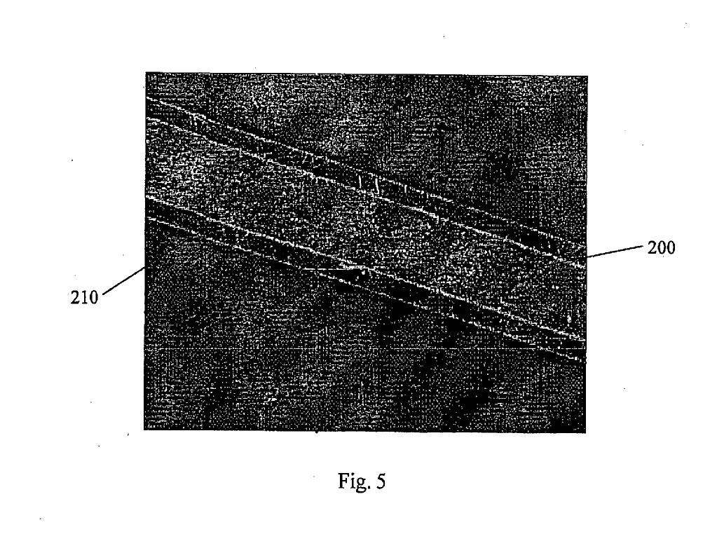

A cored wire having an alloy sheath and a core comprising WC/Co agglomerates of superfine particles was prepared. This wire would be suitable for electric arc spraying high temperature (up to about 500° C.) wear resistant coatings. The size of the WC phase in the cermet (i.e., ceramic-metal) composite was in the range of 50 to 500 nm. In preparing the cored wire, as-synthesized WC/Co particles were agglomerated into spherical granules with a size of 20 to 60 microns in a reconstitution process of spray drying. An INCONEL® 625 Ni—Cr—Mo alloy strip was used to form the sheath. First, the strip was bent into a U-shaped tube through forming rollers and fed into a die. A powder feeder system was integrated with the die, and WC/Co granules were fed into the U-shape tube via a powder port. A screw-driven mechanism at the exit of the die closed the tube into a round sheath. Finally, the wire was pulled through a die to reduce its diameter to 1.6 to 2 millimeters (mm). The end and side views of the resultant cored wire are shown in FIGS. 4 and 5, respectively. The cored wire had a WC/Co core 200 comprising agglomerates of superfine particles and an alloy sheath 210 surrounding the core 200. The cored wire was smooth, even in diameter, and had sufficient ductility and strength to be wound into a spool or a coil.

### Example 2

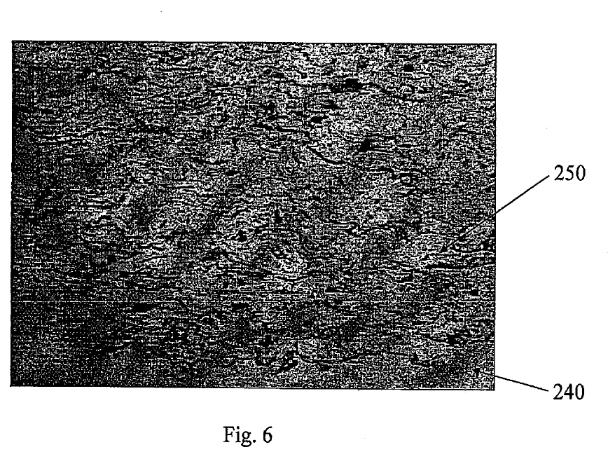

A cored wire having an alloy sheath and a composite core comprising WC/Co agglomerates of superfine particles and micron-sized Ni₃Al particles was prepared. This wire would be suitable for electric arc spraying high-temperature oxidation resistant coatings. The size of the WC phase in the cermet composite was in the range of 50 to 500 nm. In preparing the cored wire, as-synthesized WC/Co particles were agglomerated into spherical granules with a size of 20 to 60 microns in a reconstitution process of spray drying. Ni₃Al particles with a grain size of 10 to 50 microns were mechanically mixed with the WC/Co agglomerates. A Fe-20Cr alloy strip was used to form the sheath. First, the strip was bent into a U-shape tube through forming rollers and fed into a die. A powder feeder system was integrated with the die, and the mixture of WC/Co agglomerates and Ni₃Al powder were fed into the U-shape tube via a powder port. A screw-driven mechanism at the exit of the die closed the tube into a round sheath. Finally, the wire was pulled through a die to reduce its diameter to 1.6 to 2 mm. The resultant cored wire was smooth, even in diameter, and had sufficient ductility and strength to be wound into a spool or a coil. The volume percentage of WC/Co and Ni₃Al in the core of the wire is 60 to 70% and 30 to 40%, respectively. The microstructure cross-section of an electric arc sprayed coating 250 formed on a substrate 240 using the cored wire is shown in FIG. 6.

### Example 3

Cored wires having an alloy sheath and a composite core comprising oxide agglomerates of nanoparticles and WC/Co agglomerates of superfine particles were prepared. Sequentially, the cored wires were made into coatings using an electric arc spray system sold by Praxair, Inc. Table I below lists the types of cored wires prepared and the process parameters for making them. The compositions are presented as weight percentages (wt. %). The oxide nanoparticles had a size range of about 20 to 50 nm, and the WC/Co superfine particles had a size range of about 100 to 300 nm. The electric arc spray parameters were determined by the shell/core materials and resultant coatings in terms of primarily coating porosity and bond strength. These parameters include voltage (V), current in amperes (A), spray distance (S.D.) in millimeters (mm), air pressure in pounds per squared inch (psi), and air flow rate in cubic feet per minute (cfm). The resultant coatings had a thickness of about 200 to 300 microns.

TABLE 1

| Shell/Core Materials, | | Coating thickness, |
|---|---|---|
| wt. % | Main Spray Parameters | microns |
| Ni20Cr/ | Voltage: 32 V; | 200-300 |
| 24%(Cr₂O₃—10TiO₂) | Current: 100 A; | |
| | S.D: 127 mm; and | |
| | Air: 65 psi/32 cfm | |
| Ni20Cr/ | Voltage: 34 V; | 200-300 |
| 18%(Al₂O₃—13TiO₂) | Current: 110 A; | |
| | S.D: 127 mm; and | |
| | Air: 65 psi/35 cfm | |
| Ni20Cr/ | Voltage: 35 V; | 200-300 |
| 18%(Al₂O₃—10CeO₂) | Current: 100 A | |
| | S.D: 127 mm; | |
| | Air: 65 psi/30 cfm | |
| Ni20Cr/ | Voltage: 30 V; | 200-300 |
| 33%(WC—12Co) | Current: 100 A | |
| | S.D: 127 mm; | |
| | Air: 65 psi/33 cfm | |
| Stainless 304/ | Voltage: 33 V; | 200-300 |
| 25%(Cr₂O₃—10TiO₂) | Current: 110 A | |
| | S.D: 127 mm; | |
| | Air: 65 psi/34 cfm | |
| Stainless 304/ | Voltage: 30 V; | 200-300 |
| 19%(Al₂O₃—13TiO₂) | Current: 100 A | |
| | S.D: 127 mm; | |
| | Air: 65 psi/35 cfm | |
| Stainless 304/ | Voltage: 39 V; | 200-300 |
| 21(Al₂O₃—10CeO₂) | Current: 100 A | |
| | S.D: 127 mm; | |
| | Air: 65 psi/32 cfm | |
| Stainless 304/ | Voltage: 31 V; | 200-300 |
| 41%(WC—12Co) | Current: 110 A | |
| | S.D: 127 mm; | |
| | Air: 65 psi/35 cfm | |

### Example 4

A cored wire having a bi-layered alloy sheath and a composite core comprising WC/Co agglomerates of superfine particles and lubricating particles was prepared. The size of the WC phase in the cermet composite was in the range of 50 to 500 nm. In preparing the cored wire, as-synthesized WC/Co particles were mechanically mixed with BN particles, and then the mixture was agglomerated into spherical granules with a size of 20 to 60 microns in a reconstitution process of spray drying. Ni₃Al particles with a grain size of 10 to 50 microns were mechanically mixed with the WC/Co+BN agglomerates. An Al strip was used to form an inner sheath. First, the strip was bent into a U-shaped tube through forming rollers and fed into a die. A powder feeder system was integrated with the die, and the composite WC/Co+BN agglomerates were fed into the U-shaped Al tube via a powder port. A screw-driven mechanism at the exit of the die applied compression force to close the tube into a round shell. A Ni-20Cr strip was bent into a U-shaped tube, and then the Al-shelled wire was positioned in the center of the U-shaped tube. Next, the U-shaped alloy tube was closed through forming rollers and wrapped to form a bi-layered sheath wire. Finally, the wire was pulled through a die to reduce its diameter to 1.6 to 2 mm. The resultant cored wire was smooth, even in diameter, and had sufficient ductility and strength to be wound into a spool or a coil.

### Example 5

A cored wire having an alloy sheath and a composite core comprising WC/Co agglomerates of superfine particles and a fine wire was prepared. This wire would be suitable for electric arc spraying coatings that are resistant to high temperature oxidation and wear. The size of the WC phase in the cermet composite was in the range of 50 to 500 nm. In preparing the cored wire, as-synthesized WC/Co particles were agglomerated into spherical granules with a size of 20 to 60 microns in a reconstitution process of spray drying. A Ni-20Cr strip was used to form a sheath. First, the strip was bent into a U-shaped tube through forming rollers and fed into a die. Then, a fine Al wire having a diameter of 0.5 mm was positioned relative to the central line of the U-shaped tube. A powder feeder system was integrated with the die, and the WC/Co agglomerates were fed into the U-shaped tube with a central wire via a powder port. A screw-driven mechanism at the exit of the die applied a compression force to close the tube into a round sheath. Finally, the wire was pulled through a die to reduce its diameter to 1.6 to 2 mm. The resultant cored wire was smooth, even in diameter, and had sufficient ductility and strength to be wound into a spool or a coil.

As used herein, the terms “a” and “an” do not denote a limitation of quantity, but rather denote the presence of at least one of the referenced items. Moreover, the endpoints of all ranges directed to the same component or property are inclusive of the endpoint and independently combinable (e.g., “about 5 wt % to about 20 wt %,” is inclusive of the endpoints and all intermediate values of the ranges of about 5 wt % to about 20 wt %). Reference throughout the specification to “one embodiment”, “another embodiment”, “an embodiment”, and so forth means that a particular element (e.g., feature, structure, and/or characteristic) described in connection with the embodiment is included in at least one embodiment described herein, and might or might not be present in other embodiments. In addition, it is to be understood that the described elements may be combined in any suitable manner in the various embodiments. Unless defined otherwise, technical and scientific terms used herein have the same meaning as is commonly understood by one of skill in the art to which this invention belongs.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A cored wire comprising: a metallic sheath at least partially surrounding a core comprising agglomerates of superfine particles, nanoparticles, or a combination comprising at least one of the foregoing particles.

2. The cored wire of claim 1, wherein the metallic sheath comprises one or more layers of different compositions.

3. The cored wire of claim 1, wherein the metallic sheath comprises an outer alloy shell and an inner metal shell having different compositions.

4. The cored wire of claim 1, wherein the agglomerates have an average size of about 10 to about 200 micrometers.

5. The cored wire of claim 1, wherein the superfine particles and the nanoparticles have the same composition or have different compositions.

6. The cored wire of claim 1, wherein the superfine particles or the nanoparticles comprise a metal oxide, a carbide, a nitride, a boride, a lubricant, a dispersion strengthening additive, an alloy additive, or a combination comprising at least one of the foregoing.

7. The cored wire of claim 1, wherein the core further comprises micron-sized metallic particles mixed with the agglomerates or present in the agglomerates.

8. The cored wire of claim 1, wherein the agglomerates further comprise micron-sized particles.

9. The cored wire of claim 1, wherein the core further comprises a metallic wire and the agglomerates at least partially surround the metallic wire.

10. The cored wire of claim 1, wherein the agglomerates have a bi-modal or multi-modal size distribution for increasing a packing density of the core.

11. A method of making a cored wire, comprising:
agglomerating superfine particles, nanoparticles, or a combination comprising at least one of the foregoing particles to form agglomerates;
shaping a metallic strip into a U-shaped tube;
concurrently feeding the U-shaped tube to a die and the agglomerates to an interior of the U-shaped tube; and
closing the U-shaped tube to form a sheath at least partially surrounding the agglomerates, thereby forming the cored wire.

12. The method of claim 11, further comprising pulling the cored wire through another die to reduce its diameter.

13. The method of claim 11, further comprising mixing micron-sized metallic particles with the agglomerates subsequent to said agglomerating.

14. The method of claim 11, wherein the agglomerates further comprise micron-sized particles.

15. The method of claim 11, wherein the agglomerates have a bi-modal or multi-modal size distribution for increasing a packing density of the core.

16. The method of claim 11, further comprising mixing lubricant particles, a dispersion strengthening additive, or an alloy additive with the agglomerates subsequent to said agglomerating.

17. The method of claim 11, wherein said shaping the metallic strip, said concurrently feeding, and said closing the U-shaped tube are performed using an integrated die device comprising pre-forming rollers for shaping the metallic strip, a powder feeder, a powder port, and a screw system for closing the cored wire.

18. The method of claim 11, further comprising positioning a metallic wire in a center of the core wire using a guide roller.

19. The method of claim 11, further comprising shaping another metallic strip into another U-shaped tube, positioning the cored wire in an interior of the another U-shaped tube, closing the another U-shaped tube to form a multi-layered sheath wire; and pulling the multi-layered sheath wire through another die to form a final cored wire.

20. The cored wire of claim 11, further comprising sintering or remelting the agglomerates subsequent to said agglomerating to increase a density of the agglomerates.

21. A method of coating a substrate, comprising: thermal spraying a coating on a surface of the substrate using a cored wire, the cored wire comprising a metallic sheath at least partially surrounding a core comprising agglomerates of superfine particles, nanoparticles, or a combination comprising at least one of the foregoing particles.

22. The method of claim 21, wherein said thermal spraying comprises electric arc spraying, combustion flame spraying, or plasma spraying.

23. The method of claim 21, wherein the metallic sheath comprises one or more layers of different composition.

24. The method of claim 21, wherein the core further comprises micron-sized metallic particles.

25. The method of claim 21, wherein the core further comprises a metallic wire and the agglomerates at least partially surround the metallic wire.

26. The method of claim 21, wherein the core produces exothermal heat during said thermal spraying.

27. The method of claim 21, wherein the agglomerates have a bi-modal or multi-modal size distribution for increasing a packing density of the core.

28. The method of claim 21, further comprising heating treating, sealing, re-melting, or shot peening the coating to improve its properties.

29. The method of claim 21, wherein the coating that is produced has a different composition, a different phase structure, or a different microstructure from the sheath and the core after said thermal spraying is completed.

30. The method of claim 21, wherein the coating that is produced comprises a primary metallic phase and a secondary metallic-rich phase structure and has a microstructure comprising a metallic phase matrix with superfine particles, nanoparticles, or a combination comprising at least one of the foregoing particles dispersed therein.
